(19) United States
(12) Patent Application Publication
(10) Pub. No.: US 2007/0016900 A1
(43) Pub. Date: Jan. 18, 2007

(54) Service tool with separately updateable data file

(75) Inventors: Wayne D. Brandt, Morton, IL (US); Walter E. Earleson, Morton, IL (US); Dale B. Herget, Mapleton, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/178,505

(22) Filed: Jul. 12, 2005

(51) Int. Cl. G06F 9/44

(52) U.S. Cl. 717/168

(57) ABSTRACT

A service tool may include an input configured to receive an update including an application file and a data file update. The service tool may also include a memory configured to store a functional program and a data file, the data file being stored separate from the functional program. The service tool may also include an output configured to connect to a control device. In addition, the service tool may include a controller configured to transfer the application file to a memory associated with the control device. The controller may also be configured to update the data file with the data file update.

### TECHNICAL FIELD

The present disclosure is directed to a system and method for updating a service tool and, more particularly, to a system and method for updating a data file associated with a service program residing on the service tool.

### BACKGROUND

A service tool may be configured to service one or more machines. The service tool may include a laptop computer or other type of processor-based system configured to interface with a work machine controller or component. The service tool may run one or more diagnostic programs to determine whether the work machine controller or component is operating within expected or desired parameters. Additionally, the service tool may be configured to monitor the status, calibrate, and/or adjust settings associated with the controller or other components of a work machine.

A service tool may include a service program that assists in servicing the work machine. This program may be written in C, C++, Java or any other suitable programming language and may include a functional portion integrated with a data portion. The functional portion of the service program may assist the service tool in interacting with work machines the service tool may be used to service and also with a user using the service tool. The data portion of the service program may include data that may be used by the functional program to service a work machine and also data that may be displayed to a user. The data portion may include information particular to a certain process or component of the work machine to be serviced by the service tool. For example, using the data portion, the functional portion may run diagnostic checks on a work machine. The functional portion may also use the data portion to adjust certain parameters on the work machine. For example, the functional portion may use the data portion to display status screens for a machine or process being serviced by a service tool. The functional portion may also read data from the data portion to calibrate a component being serviced by a service tool.

In many instances, the data portion of the service program may be unique to a particular device or set of devices being serviced by the service tool. Thus, to increase the number of devices that the service tool can interact with, or to vary the operating characteristics of the service tool with respect to one or more of the devices, the data portion of the service program may require updating. For example, if a particular engine controller receives a software upgrade that enhances or adds to the controller's capabilities, it may be necessary to update the data portion of the service program to enable the service tool to properly interact with the upgraded engine controller.

It may, however, be unnecessary to update the functional aspects of the service program for each upgrade to a device or addition of a device that the service tool interacts with. This is because the functional portion of the service program may be independent of the devices being serviced by a service tool and is, therefore, generic in nature. For example, the functional portion of a service program may only include code related to displaying data from the data portion to a user, whatever that data might be. It may be the data that is displayed to the user that may be unique to the device being serviced by the service tool. Nevertheless, in view of the integrated nature of the service program (e.g., both data and functional portions being integrated together into a single program), a full upgrade to the service program is needed each time a change or addition is needed to the data portion of the service program.

Upgrading the entire service program on a service tool may be difficult and inefficient. For example, even to add a simple data update to the service program, the program may require additional coding, linking, and compiling. Such a process can result in errors, especially where the service program constitutes many lines of code, ancillary files, etc. Further, each service tool may be configured to operate with a large number of devices, which can contribute to a sizeable service program. Installation of the service program, therefore, may require a significant amount of time. To install a full service program upgrade on the large number of service tools that may be used in an enterprise, especially for only a few needed modifications to the data portion of the service program, could waste significant resources.

Thus, a need exists for simplifying the process for configuring a service tool to operate with additional or upgraded work machine components. Certain systems have been proposed that enable updating the data portion of a service program separately from the service program itself. One such system is described in U.S. Pat. No. 6,487,717 B1 (“the '717 patent”) to Brunemann et al., which issued on Nov. 26, 2002. The '717 patent describes a system and method for controlling an engine component by downloading/uploading software to a microprocessor that controls the engine component. The '717 system includes a remote interface device that may be configured to download data or software to a microprocessor memory. If data is being downloaded for the microprocessor, then the remote interface device may determine the appropriate memory location to store the data on the microprocessor depending upon where the microprocessor's algorithms look for the data. The system also includes a data change indicator, which may inform the machine owner that a particular microprocessor has received a data file update.

While the '717 system may allow for a data portion upgrade on a microprocessor, it has several shortcomings. For example, the '717 system is limited to a single controller. It may be unsuitable for use with a service program on a service tool, which may be configured to service multiple controllers. The '717 system also does not generate a data file update for the service tool. Instead, the '717 system merely downloads/uploads data that is preconfigured.

The present disclosure is directed to overcoming one or more of the problems of the prior art component update system.

### SUMMARY OF THE INVENTION

One aspect of the present disclosure includes a service tool. The service tool may include an input configured to receive an update including an application file and a data file update. The service tool may also include a memory configured to store a functional program and a data file, the data file being stored separate from the functional program. The service tool may also include an output configured to connect to a control device. In addition, the service tool may include a controller configured to transfer the application file to a memory associated with the control device. The controller may also be configured to update the data file with the data file update.

Yet another aspect of the present disclosure includes a system for building a data file update for a service tool. The system may include a system design tool configured to receive an input including a characteristic desired by a user. The system may also include a controller configured to generate an application file based on the characteristic included in the input, the application file being operational to be used by a control device serviced by the service tool. The controller may also be configured to generate a data file update relating to the application file, the data file update being configured for transfer to the service tool where it is accessed by a functional program of the service tool. The controller may also be configured to prepare an output including the application file and data file update for transfer to the service tool.

Yet another aspect of the present disclosure includes a method for updating a service tool. The method may include receiving an update on the service tool including an application file and a data file update. The method may also include storing a functional program and a data file update on the service tool, the data file being stored separate from the functional program. The method may also include connecting the service tool to a control device. The application file may be transferred to a memory associated with the control device. The method may also include updating the data file, that is separate from a functional program that resides on the service tool and accesses the data file, with the data file update.

Yet another aspect of the present disclosure includes an alternate system for building a data file update for a service tool. The system may include a system design tool configured to receive an input including a characteristic desired by a user. The system may also include a controller configured to generate a data file update, the data file update relating to a specific application file operational to be used by a control device serviced by the service tool, for transfer to the service tool, where it is accessed by a functional program of the service tool.

### BRIEF DESCRIPTION OF THE DRAWINGS

FIG. 1 is a block diagram representation of a service tool updating system according to an exemplary disclosed embodiment.

FIG. 2 is a block diagram representation of a control device according to an exemplary disclosed embodiment.

FIG. 3 is a block diagram representation of a service tool according to an exemplary disclosed embodiment.

FIG. 4 is a block diagram representation of a design environment according to an exemplary disclosed embodiment.

FIG. 5 is a block diagram of an output file according to an exemplary disclosed embodiment.

### DETAILED DESCRIPTION

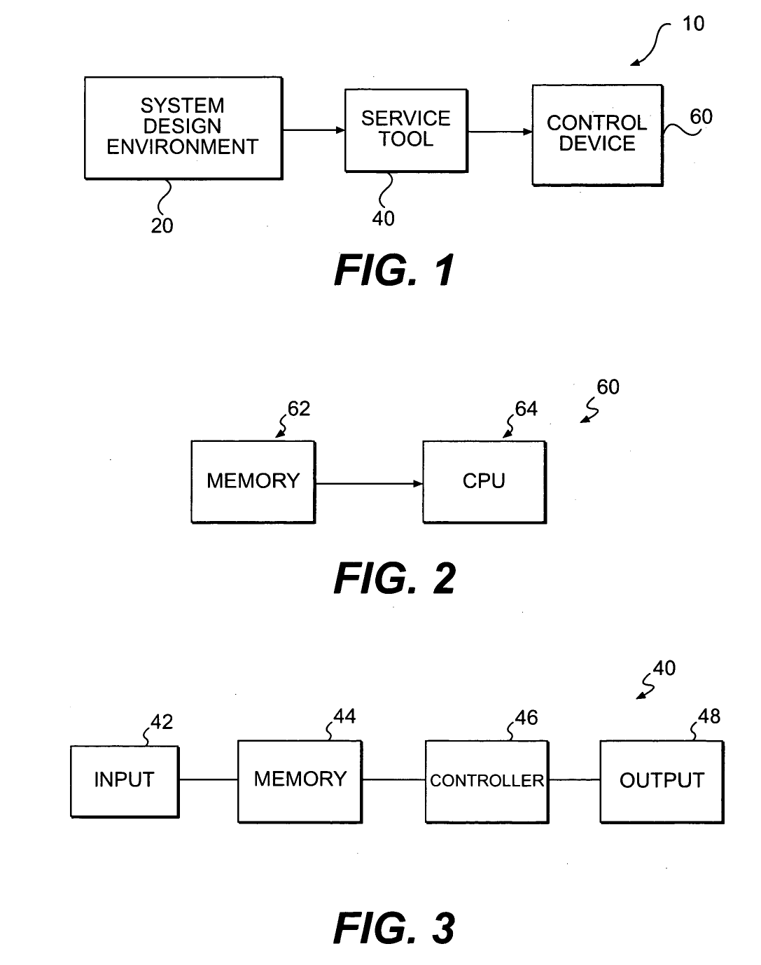

FIG. 1 provides a block diagram representation of a service tool updating system 10. System 10 may include a design environment 20, a service tool 40, and a control device 60.

Control device 60 may include a controller for a work machine or work machine component. A work machine may be a track type tractor, a truck, wheeled tractor, dump truck, automobile, on-highway vehicle, off-highway vehicle, skid-steer, stationary generator, air compressor or any other such machine. Control device 60 may include a device that is used to control/operate some function or component of the work machine. For example, control device 60 may include an engine controller to control knocking in an engine, a regeneration controller to regenerate a particulate trap, or a controller to calibrate a joystick etc. Control device 60 may use an application program running on it to perform these and other similar functions. The application program running on control device 60 may need upgrades, and control device 60 itself may need to be checked periodically to ensure that it is operating within a desired range. Service tool 40 may be configured to provide application program updates to control device 60 and perform diagnostic checks on control device 60 in addition to performing other functions.

Service tool 40 is a device that may be configured to interact with control device 60. In an exemplary embodiment, service tool 40 may be configured as a computing device (e.g., a laptop computer that can interface with control device 60). Service tool 40 may perform at least two functions. It may transfer upgrade files for the application program running on control device 60 and also run diagnostic checks on control device 60. In order to perform these and other similar functions, service tool 40 may include a service program that can interface and communicate with control device 60. In certain situations, however, service tool 40 running an existing service program may not be able to interact with control device 60 if control device 60 receives an upgrade to its application program or if control device 60 is a device that has recently been added to service. This is because the service program operating on service tool 40 may not be compatible with the application program running on control device 60. Thus, the service program operating on service tool 40 may need to be updated from time to time. Service tool 40 may be configured to receive updates for its service program and also updates for the application program operating on control device 60 from design environment 20.

Design environment 20 may be configured to develop updates for the service program operating on service tool 40 and for the application program operating on control device 60. Design environment 20 may also be configured to interact with service tool 40. Design environment 20 may be configured as a computing device such as, for example, a laptop or other such device. Design environment 20 may be configured to receive an input from a user indicating some desired characteristics relating to operational characteristics of the application program for control device 60 and/or the service program for service tool 40. These characteristics may relate to the functions performed by control device 60. For example, if control device 60 is operating as an engine controller, the input characteristics may relate to setting the air-to-fuel ratio at which knocking in an engine may be reduced etc. Additionally or alternatively, if service tool 40 is configured to service control device 60 which is used to control knocking, then the input characteristics may relate to allowing a user to use service tool 40 to set the air-to-fuel ratio on control device 60. Based on these and other similar characteristics, design environment 20 may produce an output including updates for the service program operating on service tool 40 and for the application program operating on control device 60. Design environment 20 may also be configured to transfer these updates to service tool 40.

FIG. 2 provides a block diagram representation of control device 60. Control device 60 may include a memory 62 and a CPU 64. Control device 60 may be used to control various aspects of a work machine. For example, control device 60 may be configured to control functions of an engine of a work machine. For example, control device 60 operating as an engine controller may be configured to “control knocking” in an engine. “Knocking” is uncontrolled fuel combustion detrimental to emissions, fuel economy, and engine longevity. Alternatively, control device 60 may be configured as a regeneration controller to control the “regeneration” of an exhaust element in an engine of a work machine. Regeneration is the process of heating the particulate matter trapped in an exhaust element to a temperature at which the particulate matter combusts or vaporizes. In addition, control device 60 may be configured to perform other functions/operations of a work machine.

Control device 60 may be configured with an application program that may be used to operate control device 60 and control various functions. Specifically, the application program may be used to control the interaction of control device 60 with service tool 40. For example, the application program may be configured to determine when service tool 40 is connected to control device 60 and control the exchanging of files between service tool 40 and control device 60. These files may include updates for the application program operating on control device 60. The application program may also be configured to perform other operations for control device 60. Furthermore, the application program may be configured to control various engine operations controlled by control device 60. For example, if control device 60 is configured as a regeneration controller, the application program may be configured to determine the time to start and stop regeneration based on the various inputs provided to control device 60. The application program may also be configured to perform other such engine functions for control device 60.

Memory 62 associated with control device 60 may be configured to store the application program operating on control device 60. Memory 62 may include a ROM and/or a RAM. If memory 62 includes a RAM, it may be configured as a DRAM, SCRAM, or SRAM chip, or a combination thereof. In addition any other storage medium operable to hold application program 20 may be used as memory 62. In an exemplary embodiment, memory 62 may be integrated with control device 60 such that they form one physical unit. In other embodiments, memory 62 may be located physically outside of control device 60 as a separate unit.

CPU 64 in association with the application program in memory 62 may be configured to control the operations of control device 60. Specifically, CPU 64 may assist control device 60 in interacting with service tool 40 and may also assist control device in controlling various engine functions such as knocking, regeneration etc. In addition, CPU 64 may be configured to control other appropriate operations of control device 60.

CPU 64 may be configured to control the exchange of files between service tool 40 and control device 60. For example, CPU 64 may process the updates for the application program that control device 60 may receive from service tool 40. In addition, CPU 64 may assist control device 60 in responding to signals sent to control device 60 by service tool 40 and other components of a work machine and/or proactively send signals to these devices. For example, if service tool 40 sends dummy signals to control device 60 as part of a diagnostic check sequence, CPU 64 may be configured to respond to these signals.

CPU 64 may include a processor operable with the application program stored in memory 62. For example, CPU 64 may include a microprocessor wherein the microprocessor may be a generic processor or a processor specifically manufactured to operate with the application program stored in memory 62.

FIG. 3 provides a block diagram representation for service tool 40. Service tool 40 may include an input 42, a memory 44, a controller 46, and an output 48. Service tool 40 may be configured to service controllers and other components of a work machine. In an exemplary embodiment, service tool 40 may be configured to service control device 60. In order to service control device 60 and to perform other functions, service tool 40 may operate a service program. Service tool 40 may be configured such that updates for the application program operating on control device 60 and updates for the service program may be received through input 42 and stored in memory 44. Controller 46 may be configured to transfer the updates for the application program running on control device 60 to control device 60 using output 48. In addition, controller 46 may be configured to update the service program of service tool 40 with the service program updates stored in memory 44.

Service tool 40 may be configured to interact with suitable devices. For example, in an exemplary embodiment, service tool 40 may be configured to interact with design environment 20 and control device 60. In addition, service tool 40 may be configured to interact with other appropriate devices. Service tool 40 may be configured as a hand-held or portable computing device to interact with design environment 40 and control device 60. For example, service tool 40 may be configured as a laptop computer or any other such device.

Service tool 40 may be configured such that it may be suitably connected to control device 60 in order to service control device 60. In an exemplary embodiment, service tool 40 may be connected to control device 60 using a wire connection. For example, if the pin outs on a port on service tool 40 do not match the pin outs on control device 60, service tool 40 may connect to a communication adaptor that may be connected to control device 60. Alternatively, if the pin outs of service tool 40 and control device 60 match, the two may be directly connected to each other. Alternatively, service tool 40 may be connected to control device 60 using optical fiber, wireless or other suitable means.

Service tool 40 may service control device 60 in various forms. These forms may include running diagnostic checks on control device 60 and transferring updates for the application program running on control device 60. During the servicing of control device 60, service tool 40 may run diagnostic checks on control device 60 in order to determine the status of control device 60. These diagnostic checks may be achieved, for example, by sending dummy signals to control device 60 and monitoring the signals provided by control device 60 in response to these dummy signals. If the signals received from control device 60 fall within a desired range, service tool 40 may determine that control device 60 is operating satisfactorily. Service tool 40 may also be configured to transfer files to control device 60. For example, service tool 40 may send files including updates for the application program running on control device 60. In addition, service tool 40 may send other such files to control device 60. Service tool 40 may also be configured to allow a user to adjust settings on control device 60 in order to control the operation of a work machine. For example, if control device 60 is a regeneration controller configured to control the regeneration of a particulate trap in a work machine, service tool 40 may be configured to allow a user to adjust the regeneration duration for the particulate trap. A user may adjust the regeneration duration by logging on to service tool 40 that may be connected to control device 60 and adjusting, for example, a “regeneration duration” setting on the application program running on control device 60.

Service tool 40 may include a service program that assists in controlling the operation of service tool 40 and also in servicing control device 60. This program may be written in C, C++, Java or any other suitable programming language and may include a functional portion and a data portion. The functional portion of the service program may assist service tool 40 in handling general functions. These functions may include interacting with control device 60 and a user using service tool 40. For example, the functional portion of the service program on service tool 40 may allow service tool 40 to read data input into service tool 40 via an input device such as a keyboard. The functional portion may also assist the service program in displaying menus to a user on a display screen in service tool 40. These menus may help a user use service tool 40 to service control device 60. For example, if a user wants to change the regeneration duration settings on control device 60 that functions as a regeneration controller, the functional portion may display menus which may display the current regeneration duration settings on control device 60 and the possible ranges that may be selected by a user (e.g., 0-10 s, 10 s-20 s etc.).

The data portion of the service program may include data that may be read by the functional portion of the service program in order to service control device 60 and also data that may be displayed by the functional portion to a user. This data may include information particular to a certain process or component of the work machine to be serviced by control device 60. The functional portion may also use the data portion to adjust certain parameters on the work machine. Using the regeneration example discussed above, the functional portion may use the data from the data portion to display content in the menus for servicing control device 60. This content may include the current numerical settings and the possible numerical ranges for regeneration duration (e.g., 0-10 s, 10 s-20 s etc.) displayed on the menus that a user may choose from. Thus, in the example above, while the functional portion of the service program may be configured to display the menus to the user, the actual content of the menus i.e., current numerical settings and numerical ranges available to the user, may be obtained by the functional portion from the data portion of the service program.

The data portion of the service program operating on service tool 40 may be related to the application program operating on control device 60. In the example described above, the application program running on control device 60 pertains to controlling regeneration, and the data included in the data portion (i.e., the regeneration duration ranges) are related to regeneration.

While the above-mentioned explanation of the interaction between the data portion and functional portion uses an example of control device 60 operating as a regeneration controller, it should be noted that depending on the kind of data included in the data portion, various other tasks may be performed by the functional portion of the service program on service tool 40 in association with the data portion of the service program. For example, the data portion may include data pertaining to calibration of a joystick. In an exemplary embodiment, the menus displayed by the functional portion may include data pertaining to calibration of a joystick. The data may include, for example, the range of motion allowable for a given input signal. For example, an input signal of 0-5V may correspond to a range of motion of up to 5 degrees on a particular axis.

It should be noted that while for different applications, the data included in the data portion of a service program on service tool 40 (e.g., content displayed on a menu) may vary or be updated, the functional portion of the service program (i.e., the portion displaying menus) may stay the same.

The service program on service tool 40 may be designed such that the data portion of the service program may be separately updateable from the functional portion of the service program. In an exemplary embodiment, the data portion and the functional portion of a service program on service tool 40 may be configured, for example, as two separate software entities (e.g., files, etc.) The data portion of the service program may be referred to as a data file. The functional portion of the service program may be referred to as a functional program. The functional program may be configured so that it may read data from the data file separate from data that may be integrated with the functional program itself. Thus, when the data portion of the service program needs to be updated, the data file may be updated separately from the functional program, and the functional program may be left unmodified.

Service tool 40 may be configured to receive updates for the data portion of the service program and for the application program operating on control device 60 from design environment 20. These updates may be received by service tool 40 on input 42.

Input 42 may include a data port on service tool 40 configured to receive updates from system design environment 20. Input 42 may include various types of data ports depending on the mode of file transfer used to transfer files including updates from design environment 20 to service tool 40. For example, if files from design environment 20 are transferred to service tool 40 over a network connection, then input 42 may be configured as a network port such as an Ethernet port, T1 port, T3 port, Asynchronous Transfer Mode (“ATM”) port or any other such port. Alternatively, if files from design environment 20 are transferred to service tool 40 through a portable computer readable medium such as a CD, DVD, magnetic tape, floppy disk etc., then input 42 may be configured as a drive configured to read such medium. Such drives include, for example, a CD drive, DVD drive, floppy drive etc.

Memory 44 may be configured to store information on service tool 40. Specifically, memory 44 may be configured to store updates received on input 42. In addition, memory 44 may be configured to store the service program operating on service tool 40. Thus, memory 44 may be configured to store the service program that includes the functional portion and the data portion, updates for the data portion of the service program, and updates for the application program operating on control device 60. Memory 44 may include a ROM and/or a RAM. If memory 44 includes a RAM, it may be configured in at least one of a DRAM, SDRAM, and SRAM chip or a combination thereof. In addition any other storage medium operable to hold the above-mentioned contents may be used as memory 44.

Controller 46 may include any device suitable for running a software application. For example, controller 46 may include a CPU, RAM, I/O modules etc. Controller 46 may be configured such that it may run the service program on service tool 40. For example, controller 46 may be configured to update the data portion of the service program running on service tool 40. Controller 46 may also be configured to perform functions suitable for service tool 40. Specifically, controller 46 may be configured to service control device 60. For example, controller 46 may run diagnostic checks on control device 60 in order to determine the status of control device 60. Controller 46 may also be configured to transfer files, such as files including updates for the application program on control device 60, to control device 60. Controller 46 may also be configured to allow a user to adjust settings on control device 60 in order to control the operation of a work machine. For example, if control device 60 is a regeneration controller, controller 46 may be configured to allow a user to adjust the regeneration duration setting on control device 60. Controller 46 may also be configured to perform any other function appropriate for the working of service tool 40. It should be noted that while an exemplary embodiment discloses memory 44 as being separate from controller 46, in other embodiments, memory 44 may be configured to be part of controller 46.

Output 48 may include a port operable to connect and transfer information from service tool 40 to control device 60. If for example, control device 60 is configured to operate as a controller in a work machine, output 48 may be configured as a data link port. This data link port may be configured to operate with a data link protocol such as, for example, J1939. In this example, an input port (not shown) on control device 60 would also be configured as a data link port operable with a data link protocol. In addition, any other interface operable to transfer information between service tool 40 and control device 60 may be used as output 48.

Design environment 20 may be configured to develop updates for the data portion of the service program operating on service tool 40 and for the application program operating on control device 60. Design environment 20 may also be configured to transfer these updates to service tool 40.

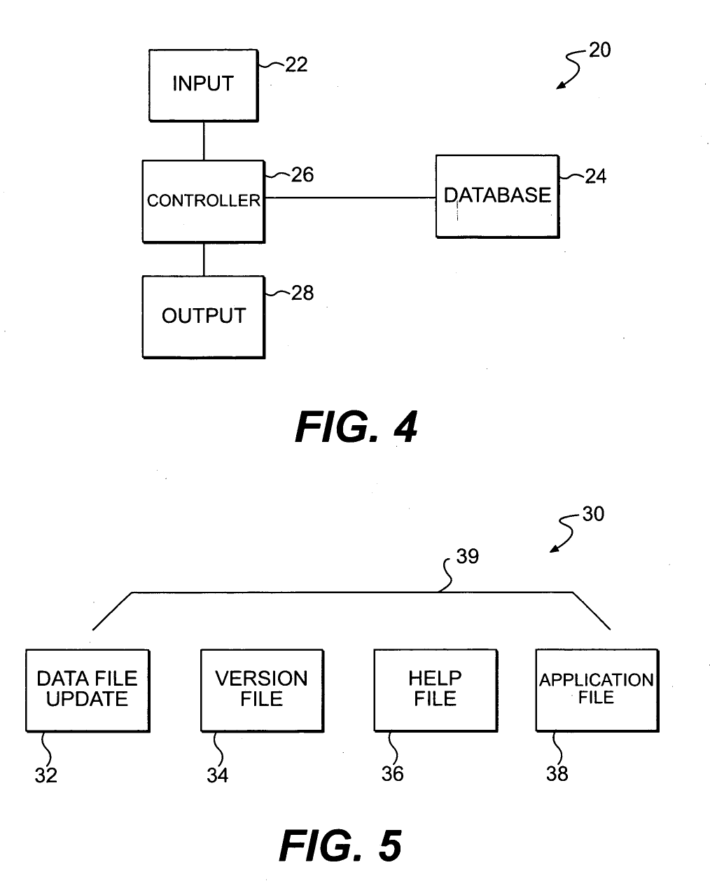

FIG. 4 provides a block diagram representation of design environment 20. Design environment 20 may include an input 22, a database 24, a controller 26, and an output 28. Based on characteristics desired by a user provided to input 22, controller 26 may be configured to use objects stored in database 24 to produce updates for the data portion of the service program operation on service tool 40. Furthermore, based on characteristics desired by a user provided to input 22, controller 26 may also be configured to produce updates for the application program operating on control device 60 using objects stored in database 26. The updates for the data portion, updates for the application program, and any other files developed by design environment 20 may be transferred to service tool 40 through output 28.

Design environment 20 may include a user input 22 that provides characteristics desired by a user to design environment 20. These characteristics may form the basis on which an output may be developed in design environment 20. The user-desired characteristics may relate to the functions performed by control device 60. Using the regeneration example from above, where control device 60 operates as a regeneration controller, the characteristics desired by the user may pertain to increasing the numerical ranges available for regeneration duration. For example, if the existing ranges were 0-5 s and 5 s-10 s, the user may desire to increase the ranges of regeneration duration to 0-10 s and 10 s-20 s. Thus, the characteristic desired by the user is to increase the regeneration duration ranges to 0-10 s and 10 s-20 s. In addition, input 22 may include characteristics pertaining to other functions of control device 60.

User input 22 may be provided in various forms. For example, environment 20 may include a Graphical User Interface (“GUI”) (not shown) for a user to help him provide an input. The GUI may be part of a system design tool (a software tool) configured to receive input from the user. Alternatively, a preconfigured file including user requirements may be used as user input 22. In another instance, a keyboard (not shown) may be used to provide a user input. In addition, any other suitable form of input may be used as user input 22.

Database 24 may include objects that may be used to develop updates for the data portion of the service program operating on service tool 40. These objects may be known as data objects. Database 24 may also include objects that may be used to develop updates for the application program operating on control device 60. These objects may be known as application objects.

Data objects may include data that may be displayed to a user using the service program on service tool 40. Using the regeneration example from above, data objects may include code that permits the functional portion of the service program on service tool 40 to display the numerical ranges of 0-10 s and 10 s-20 s to a user. The user may then choose a regeneration duration within any of the two regeneration ranges. In addition, data objects may include code to build files including data for other functions that may be performed by service tool 40.

Application objects, on the other hand, may include pieces of code that may be used to build updates for the application program running on control device 60. Using the regeneration example from above, application objects may include code that may configure control device 60 so that control device 60 may permit regeneration durations of 0-10 s and 10 s-20 s. Thus, code included in application objects may cause control device 60 to drive a regeneration device (not shown) for a regeneration duration of 0-10 s or 10 s-20 s (depending on the choice made by the user).

Application objects and data objects may include code that may written in any suitable language such as C, C++, Visual C++, Visual Basic, etc. In addition other such languages may be used to develop application objects and data objects.

Database 24 may include a software running on a piece of hardware to form a Relational Database Management System. For example, database software designed by vendors such as Oracle and PeopleSoft that runs on hardware such as Sun or Dell servers may be used to store the application objects and data objects. Alternatively, any other form of software suitable for holding application objects and data objects may be used as database 24.

Controller 26 may be configured to develop updates for the service program operating on service tool 40 and the application program operating on control device 60. Specifically, controller 26 may be configured to use objects stored in database 24 to produce updates for the data portion of the service program operating on service tool 40. Additionally, controller 26 may also be configured to produce updates for the data portion using input directly provided by a user to input 22. For example, a user may provide data, such as numerical values, either manually through a keyboard or through an input file, or through a GUI. This data may be used by controller 26 to produce updates for the data portion of the service program operating on service tool 40. Controller 26 may also be configured to develop updates for the application program operating on control device 60 using objects stored in database 26. The updates developed by controller 26 may be transferred as files to service tool 40. In addition controller 26 may be configured to perform other appropriate functions for design environment 20. These functions may include developing additional files, transferring files through output 28 to service tool 40, etc.

Controller 26 may include any devices suitable for running a software application. For example, controller 26 may include a CPU, RAM, I/O modules etc. In one embodiment, controller 26 may constitute a unit dedicated for building files based on user input 22. Alternatively, however, controller 26 may be integrated with and/or correspond to another control unit (not shown) that may perform functions in addition to those required by system design environment 20.

Output 28 may be configured as an interface between design environment 20 and service tool 40. Output 28 may be used to transfer files between design environment 20 and service tool 40. For example, output 28 may be configured to transfer updates for the data portion of the service program operating on service tool 40 and updates for the application program operating on control device 60. These updates may be transferred as software files. In addition, output 28 may be configured to transfer other such files. Output 28 may include various types of data ports depending on the mode of file transfer used to transfer files from design environment 20 to service tool 40. For example, if files from design environment 20 are transferred to service tool 40 over a network connection, then output 28 may be configured as a network port such as an Ethernet port, T1 port, T3 port, Asynchronous Transfer Mode (“ATM”) port or any other such port. Alternatively, if files from design environment 20 are transferred to service tool 40 through a portable computer readable medium such as a CD, DVD, magnetic tape, floppy etc., then output 28 may be configured as a drive configured to prepare such a medium. Such drives may include, for example, a CD burner, DVD Write burner, floppy drive etc.

FIG. 5 represents a block diagram of output files 30. Output files 30 may be developed by design environment 20 based on the desired user characteristics provided to it. Output files 30 may include a data file update 32, a version file 34, a help file 36 and an application file 38. Some of these files may be combined into a combination file 39. Output files 30 may be configured to be transferred from design environment 20 to service tool 40.

Data file update 32 may include updates for the data portion of the service program operating on service tool 40. Version file 34 may include information that may help service tool 40 determine the version numbers of the files it is receiving from design environment 20. Help file 36 may include information that may help service tool 40 use the files it receives from design environment 20. Application file 38 may include updates for the application program operating on control device 60.

Data file update 32 may include the updates for the data portion of the service program operating on service tool 40. As noted above, these updates may be developed by controller 26 in design environment 20 based on the characteristics desired by a user that are provided to input 22 in design environment 20. Using the regeneration example from above, where control device 60 operates as a regeneration controller, the updates including the numerical ranges of 0-10 s and 10 s-20 s that may be displayed to a user using service tool 40 to service control device 60 may be included in data file update 32.

System design environment 20 may also develop a version file 34. Version file 34 may include information that may be used by service tool 40 to determine what version of the data file update, help file or application file, service tool 40 is receiving. For example, if service tool 40 is receiving version 1 of a data file update, version file 34 may include data that may convey this information to service tool 40.

Help file 36 may include instructions for a user which may help a user determine how to use any of output files 30. For example, help file 36 may include instructions for how to install the updates developed by design environment 20. Help file 36 may also include information about the minimum hardware and software requirements for service tool 40 and control device 60 in order to install any program/update developed by design environment 20. In addition, help file 36 may include other appropriate instructions to help a user use the programs/updates developed by design environment 20.

Application file 38 may include the updates for the application program running on control device 60. As noted above, these updates may be developed by controller 26 in design environment 20 based on the characteristics desired by a user that are provided to input 22 in design environment 20. These updates may enhance or modify the capabilities of control device 60. Using the regeneration example from above, updates included in application file 38 may, when installed on control device 60, cause control device 60 to drive a regeneration device for a regeneration duration of 0-10 s or 10 s-20 s, whereas without this update, control device 60 running the existing application program may have only been able to drive a regeneration device for a regeneration duration of, say, 0-5 s.

In an exemplary embodiment, some of the output files 30 may be combined by controller 26 in design environment 20 to form a combination file 39. Use of a combination file may be beneficial because all the files developed in response to a desired user characteristic may be combined together into one file and transferred from design environment 10 to service tool 40 at one time. Furthermore combination file 28 may be zipped in order to decrease storage space on design environment 20 and/or service tool 40. Combination file 39 may also include a service manual (not shown) and any other file a user may want to include in it. In an exemplary embodiment, combination file 28 may be known as a System Integrated Data (“SID”) file.

In an exemplary embodiment, control device 60 may not need any updates for the application program running on it, but service tool 40 may need a data file update in order to service control device 60. This may occur, for example, when a control device 60 is being introduced in service with an up-to-date application program already configured on it. However, existing service tool 40 may not have the data in the data portion of its service program to service control device 60 running the up-to-date application program. Under this circumstance, system design environment 20 may develop data file update 32 for service tool 40 that is related to the application program running on control device 60. However, design environment 20 may not develop application file 38 because it may not be needed by control device 60. Thus, output files 30 may only include data file update 32. Output files 30 may also include version file 34 and help file 36 that may be combined with data file update 32 to form combination file 39, which may be transferred from design environment 20 to service tool 40. In addition, there may be other circumstances in which output files 30 may only include a data file update and not an application file.

In yet another exemplary embodiment, control device 60 may indeed need an update for the application program running on it. In order for service control 40 to service control device 60 after control device 60 receives the update for the application program, service tool 40 may also need a data update for the data portion of its service program. Under this circumstance, design environment 20 may produce both data file update 32 for the data portion of the service program on service tool 40 and application file 38 for the application program running on control device 60. Data update 32 and application file 38 may be then transferred from design environment 20 to service tool 40, either as part of combination file 39, or separately.

### INDUSTRIAL APPLICABILITY

By allowing for the data portion of a service program to be updated separately from the functional portion, a service tool may be updated more frequently and more quickly than a service tool running on a service program whose data portion is integrated with the functional program. This is because the data portion of the service program may be generally smaller than the functional portion. By just performing the data portion update, the additional coding, linking, and compiling that may need to be performed to update the entire service program may no longer be needed. This reduction in complication in the update process may allow for more frequent updates to the service tool if necessary. By allowing for more frequent updates to the service tool, the disclosed system and method may make more service tools available for service. Furthermore, the disclosed system may allow for the data portion of the functional program to be updated simultaneously with the software upgrade on a control device, thus reducing the total upgrade time for a service tool and a control device.

The data portion of a service program on a service tool configured to service a control device may be unique to the application program running on the control device. By developing and packaging the data file update with the application file that may be used to update the application program and by installing the data update on a service tool that will service the control device running the application program, the disclosed system and method may ensure that only those service tools that actually need a data file update to service a control device receive the data file update. This may help reduce the number of service tools that receive an upgrade.

Simultaneous installation of a data file update on a service tool and an application file on a control device may have another advantage. By the time a service tool is ready to service a control devise using the application file, the service tool already has the up-to-date data file needed to service the control device. This reduces the time to service a control device because, rather than updating the service tool with the appropriate data file after a decision is made to use the service tool, the service tool already has the appropriate data file needed to service the control device at the time the decision to use the service tool has been made.

It will be apparent to those skilled in the art that various modifications and variations can be made in the disclosed service tool and system without departing from the scope of the disclosure. Additionally, other embodiments of the disclosed system will be apparent to those skilled in the art from consideration of the specification. It is intended that the specification and the examples be considered exemplary only, with a true scope of the disclosure being indicated by the following claims and their equivalents.

What is claimed is:

1. A service tool comprising:
an input configured to receive an update including an application file and a data file update;
a memory configured to store a functional program and a data file, the data file being stored separate from the functional program;
an output configured to connect to a control device;
a controller configured to:
transfer the application file to a memory associated with the control device; and
update the data file with the data file update.

2. The service tool of claim 1, wherein the input is further configured to receive at least one of a version file and a help file along with the application file and data file update.

3. The service tool of claim 1, wherein the functional program is configured to read data from the data file.

4. The service tool of claim 1, wherein the data file is used by the functional program on the service tool to service the control device using the application file.

5. The service tool of claim 1, wherein the application file is configured to control at least one operation of the control device.

6. A system for building a data file update for a service tool comprising:
a system design tool configured to receive an input including a characteristic desired by a user;
a controller configured to:
generate an application file based on the characteristic included in the input, the application file being operational to be used by a control device serviced by the service tool;
generate a data file update relating to the application file, the data file update being configured for transfer to the service tool where it is accessed by a functional program of the service tool; and
prepare an output including the application file and data file update for transfer to the service tool.

7. The system of claim 6, wherein the data file update is configured to update a data file on the service tool.

8. The system of claim 6, wherein the application file is configured to control at least one operation of the control device.

9. The system of claim 6, further including a database including a plurality of application objects and data objects.

10. The system of claim 9, wherein the controller is configured to generate the application file using at least one of the plurality of application objects.

11. The system of claim 9, wherein the controller is configured to generate the data file update using at least one of the plurality of data objects.

12. The system of claim 7, wherein the data file is operably separate from the functional program on the service tool.

13. The system of claim 7, wherein the data file is used by the functional program on the service tool to service the control device using the application file.

14. The system of claim 6, wherein the output further includes at least one of a version file and a help file along with the data file update and the application file.

15. A method for updating a service tool comprising:
receiving an update on the service tool including an application file and a data file update;
storing a functional program and a data file on the service tool, the data file being stored separate from the functional program;
connecting the service tool to a control device;
transferring the application file to a memory associated with the control device; and
updating the data file, separate from a functional program that resides on the service tool and accesses the data file, with the data file update.

16. The method of claim 15, wherein the update further includes at least one of a version file and a help file.

17. The method of claim 15, wherein the functional program is configured to read data from the data file.

18. The method of claim 15, wherein the data file is used by the functional program on the service tool to service the control device.

19. The method of claim 15, further including updating the functional program separate from the data file.

20. The method of claim 15, wherein the data file update includes information associated with operation of the application file by the control device.

21. A system for building a data file update for a service tool comprising:
a system design tool configured to receive an input including a characteristic desired by a user;
a controller configured to:
generate a data file update, the data file update relating to a specific application file operational to be used by a control device serviced by the service tool, for transfer to the service tool, where it is accessed by a functional program of the service tool; and
prepare an output including the data file update for transfer to the service tool.

22. The system of claim 21, wherein the output further includes at least one of a version file and a help file.
